(19) United States
(12) Patent Application Publication
(10) Pub. No.: US 2009/0310512 A1
(43) Pub. Date: Dec. 17, 2009

(54) METHOD AND APPARATUS FOR CREATING ROUTER CONFIGURATION

(76) Inventors: SUBHABRATA SEN, Providence, NJ (US); Albert G. Greenberg, Seattle, WA (US); Charles Kalmanek, Short Hills, NJ (US); Patrick Drew McDaniel, State College, PA (US)

Correspondence Address: AT & T LEGAL DEPARTMENT - WT, PATENT DOCKETING, ROOM 2A-207, ONE AT& T WAY, BEDMINSTER, NJ, 07921, US

(21) Appl. No.: 12/140,068

(22) Filed: Jun. 16, 2008

(51) Int. Cl. H04L 12/28

(52) U.S. Cl. 370/254

(57) ABSTRACT

A method and apparatus for creating one or more router configurations in a network are disclosed. For example, the method receives a request to create a router configuration, and retrieves automatically one or more templates in response to the request. The method then instantiates the router configuration by applying the one or more templates.

This application is related to application ATT/2006-A2124, being filed concurrently.

The present invention relates generally to communication networks and, more particularly, to a method and apparatus for creating router configuration in networks, e.g., Internet Protocol (IP) networks, Voice over Internet Protocol (VOIP) networks, Virtual Private Networks (VPN), and the like.

### BACKGROUND OF THE INVENTION

A network service provider may perform router configurations through a manual process. However, manual configuration is error prone and may result in configurations that are in conflict with engineering intent. Furthermore, as the network expands, the number of routers and the router complexities will increase, thereby increasing the cost of manual configuration of a large number of routers in a network.

### SUMMARY OF THE INVENTION

In one embodiment, the present invention discloses a method and apparatus for automatically creating router configuration in a network. For example, the method receives a request to create a router configuration, and retrieves automatically one or more templates in response to the request. The method then instantiates the router configuration by applying the one or more templates.

### BRIEF DESCRIPTION OF THE DRAWINGS

The teaching of the present invention can be readily understood by considering the following detailed description in conjunction with the accompanying drawings, in which:

FIG. 1 illustrates an exemplary network related to the present invention;

FIG. 2 illustrates an exemplary network of the current invention for creating router configurations and generating templates;

FIG. 3 illustrates a flowchart of a method for creating one or more templates;

FIG. 4 illustrates a flowchart of a method for creating one or more router configurations; and

FIG. 5 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present invention broadly discloses a method and apparatus for creating router configuration in networks. Although the present invention is discussed below in the context of Internet Protocol (IP) networks, the present invention is not so limited. Namely, the present invention can be applied for other types of packet networks.

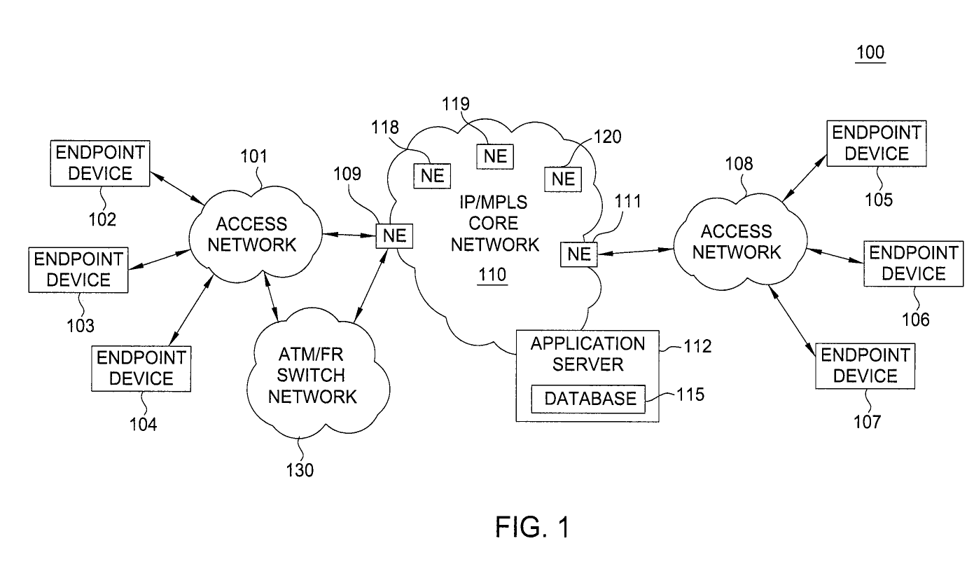

FIG. 1 is a block diagram depicting an exemplary packet network 100 related to the current invention. Exemplary packet networks include Internet protocol (IP) networks, Ethernet networks, and the like. An IP network is broadly defined as a network that uses Internet Protocol such as IPv4 or IPv6 and the like to exchange data packets.

In one embodiment, the packet network may comprise a plurality of endpoint devices 102-104 configured for communication with the core packet network 110 (e.g., an IP based core backbone network supported by a service provider) via an access network 101. Similarly, a plurality of endpoint devices 105-107 are configured for communication with the core packet network 110 via an access network 108. The network elements 109 and 111 may serve as gateway servers or edge routers for the network 110.

The endpoint devices 102-107 may comprise customer endpoint devices such as personal computers, laptop computers, Personal Digital Assistants (PDAs), servers, routers, and the like. The access networks 101 and 108 serve as a means to establish a connection between the endpoint devices 102-107 and the NEs 109 and 111 of the IP/MPLS core network 110. The access networks 101 and 108 may each comprise a Digital Subscriber Line (DSL) network, a broadband cable access network, a Local Area Network (LAN), a Wireless Access Network (WAN), a 3^{rd} party network, and the like. The access networks 101 and 108 may be either directly connected to NEs 109 and 111 of the IP/MPLS core network 110, or indirectly through another network.

Some NEs (e.g., NEs 109 and 111) reside at the edge of the core infrastructure and interface with customer endpoints over various types of access networks. An NE that resides at the edge of a core infrastructure is typically implemented as an edge router, a media gateway, a border element, a firewall, a switch, and the like. An NE may also reside within the network (e.g., NEs 118-120) and may be used as a mail server, a router, or like device. The IP/MPLS core network 110 also comprises an application server 112 that contains a database 115. The application server 112 may comprise any server or computer that is well known in the art, and the database 115 may be any type of electronic collection of data that is also well known in the art. Those skilled in the art will realize that although only six endpoint devices, two access networks, five network elements and so on are depicted in FIG. 1, the communication system 100 may be expanded by including additional endpoint devices, access networks, network elements, and/or application servers, without altering the present invention.

The above IP network is described to provide an illustrative environment in which packets for voice and data services are transmitted on networks. A network service provider may manually perform a network configuration, e.g., a router configuration, in a network. A router configuration refers to a detailed specification of the router's configuration, which in turn determines the router's behavior. In essence, the configuration is a representation of the sequence of specific commands that if typed through the router's Command Line Interface (CLI), would determine the wide set of interdependent operations in the router hardware and software. For example, service provider personnel may configure the routers in a network using each router's CLI. However, having service provider personnel configure routers for each customer order is costly, time consuming, and impractical for large networks.

In another example, a service provider may have a process for creating and loading customer router configurations. For example, the service provider may receive a customer order and have a network engineer interview the customer to assess the customer's need. The network engineer may then create a router configuration, e.g., a router staging configuration and the like. A router staging configuration refers to configurations applied at a factory before shipping the router to the customer or the network service provider.

The router staging configuration may be created using cut and paste operations of data obtained from provisioning database(s) and engineering documents. For example, the network engineer may interpret contents of the engineering documents, identify applicable sections, etc. The network engineer may then obtain provisioning information, e.g., IP addresses, interface information, etc. The router staging configuration may then be provided to the router manufacturer and applied prior to shipping. However, it is possible that the router staging configuration may contain an error. For example, the network engineer may misinterpret the content of the engineering documents and/or the customer's request. The misinterpretation may not be revealed until at a later time, e.g., until test and turn-up of the router, or it may be discovered by the customer after turn-up of the router. The reliance on the interpretation made by a network engineer to determine the engineering intent to provide the configuration for the router may cause frequent router configuration problems. Regardless of the cause, if the router staging configuration contains an error, the subsequent remedy step may be labor intensive, time consuming, and may require interruption of service to a customer.

In one embodiment, the current invention provides a method for creating router configurations using a router configuration template tool. The router configuration template tool provides a template language for creating templates that define one or more services and/or requirement for network devices. For example, the method provides a template language for defining a Virtual Private Network (VPN) service, Voice over Internet Protocol (VOIP) service, etc. In another example, the method provides a template language for expressing configuration in accordance with engineering rules (e.g., configuring features of a service) for a router, switch, etc. Thus, broadly each template provides a definition of a requirement for configuring a router to provide one or more services.

In one embodiment, the template language of the current invention comprises a language for enabling:
Context substitution; and
Functional substitution.

Context substitution refers to a direct substitution in which values for one or more variables are set using inputs obtained from a user and/or a database. In other words, context substitution enables a substitution of one or more values for one or more variables in a command string, where the one or more values are obtained from a user or a database. For example, a command string for a template language may be created for context substitution that searches for entries in a database with default values. The string may also specify the action to be performed on the entries that contain the default values, if found.

Functional substitution refers to a substitution in which values for one or more variables are set by performing one or more computations and/or operations on inputs obtained from a user and/or a database. In other words, functional substitution enables a computation and/or operation of one or more values for one or more variables in a command string, on inputs obtained from a user or a database. For example, a command string for a template language may be created for functional substitution that computes IP masks based on inputs obtained from a user and/or a database. In other words, the functional substitution describes one or more computations that can be applied to the retrieved data. However, in another example, the functional substitution may describe one or more operations that can be applied to retrieve data, e.g., defining a conditional statement that defines the criteria that must be met in order to retrieve the data. For example, the functional substitution may define a condition that must be met, e.g., in a frame relay implementation, before data is retrieved as compared to a condition set for a non-frame relay implementation, e.g., an IP implementation. In other words, the functional substitution may specify one or more conditions as to how data will be retrieved in addition to one or more computations that can be performed on and/or using the selected data after the data is retrieved.

In one embodiment, the template language may gain access to variables for context and functional substitution by querying a provisioning database. For example, the service provider may establish a database that contains a list of routers. The list of routers may be indexed by unique identifiers. Router properties may then be stored in a table and accessed as variables. The table may also include sub-router tables, e.g., for interfaces. Each service may dictate a different set of data accessibility requirements. For example, configuring one router for a service may involve extracting information from another router (e.g., a hub). Peer router properties may then need to be queried. A relational database may be provided to support multi-router and peer specific information. The query for the peer router information may then specify the router hostname.

When the provisioning database is queried, the provisioning database may return a record that defines a variable context that is used to access the context variable, e.g. <CONTEXT.VARIABLE>. The context may be used to identify subsections of the configurations to be evaluated for each record returned as a response to a query. Variables of this form (i.e. context) may be directly substituted in the text of the template. That is, the returned record from the provisioning database populates the router context. Populating the router context enables one or more templates to use the router's variables.

In one embodiment, a template language may provide new contexts by making a new database query. However, those variables are only accessible within the defined context. If a query returns multiple records, the template code within the context may be repeated, producing a loop. For example, SELECT * FROM LAN WHERE ROUTER=THIS_ROUTER has the effect of configuring multiple LAN-facing interfaces.

The template language may then be used to derive templates for complete router configurations by performing recursive evaluations of templates. For example, the template may define a new context name and a scope, with each row returned by a query producing an iteration. For example, INT is the name of the new context for the code provided below. All text between the query statement and the context closing statement, [/INT], is repeated for each returned record.

```
[INT:SELECT (*) FROM (WAN_INTERFACE) WHERE
  (WAN_INTERFACE.HOSTNAME=<ROUTER.HOSTNAME>)]
interface serial10/<INT.SLOT>/<INT.PORT>
  bandwidth <INT.BANDWIDTH>
  ip address <INT.IP> <INT.MASK>
!
[/INT]
```

Note that new context definitions may be arbitrarily nested, but they cannot define scopes spanning multiple parent scopes. That is, the nested context's closing statement must occur before its parent closing statement.

In one embodiment, the template language may support inclusion or omission of configuration options with conditional statements. For example, if a type of card is not supported for a particular implementation, the template for configuration of that card may trigger an error message.

The above template language may provide description for a structure and/or content of a configuration for a service and/or a network device. In one example, a service template language may provide descriptions of various services and provide service specific configurations. In another example, a device template language may provide description of devices (e.g., routers) and/or their components, and also provide device specific configurations.

For example, a router template language may provide descriptions of interfaces, description of connections between various components within the router, etc. For example, the router may have a list of objects (e.g., device requirements, security policies, interfaces, ports, and the like) provided in a database such as a Management Information Base (MIB). That is, the MIB may contain a fixed list of managed objects, wherein each managed object represents a resource on the router to be managed. The router template language may then provide one or more specific configurations for each of the managed objects.

The template language may also provide configuration options that are based on customer and/or network information. For example, a template language for an interface to a customer may provide configuration options that are based on customer information, e.g., customer profile, customer premise equipment type (e.g., CE router type), connectivity, etc. In another example, network information may be obtained from a network management device. In one embodiment, the customer and/or network information may be obtained from a database, e.g., an external database, a fixed database, etc. For example, the service provider may have a database for requirements pertaining to VPN services for enterprise customers, VOIP services, and so on.

The template language may then be used to create one or more templates for router configurations. The one or more templates may be router or service specific templates. For example, engineering personnel may codify the engineering documents and create one or more service and/or router specific templates using the template language. The resulting one or more templates provide command strings (e.g., statements) for a single interpretation of the engineering intent, thereby eliminating the need for multiple interpretations by multiple network engineers during customer specific configurations.

In one embodiment, the templates may be produced by assembling one or more smaller templates (configlets). For example, a configlet may be written for each type of service, type of network access, and so on. In one embodiment, a configlet may contain one or more other configlets.

In one embodiment, the current method enables one or more templates to be created for combinations of services. For example, a service provider may compose services based on customer requirements. One or more templates may then be configured to meet the requirements of multiple services.

The current method then automatically creates an instance of a device configuration by executing the one or more templates. The execution comprises populating the various customer, service, network and router information, and creating an instance of a device configuration using the populated information. For example, if the customer information indicates that the Customer Edge (CE) router has no protection capability at the transport layer, then an appropriate router configuration will be created accordingly to address the device requirements of the CE router and/or services or service features supported by the CE router.

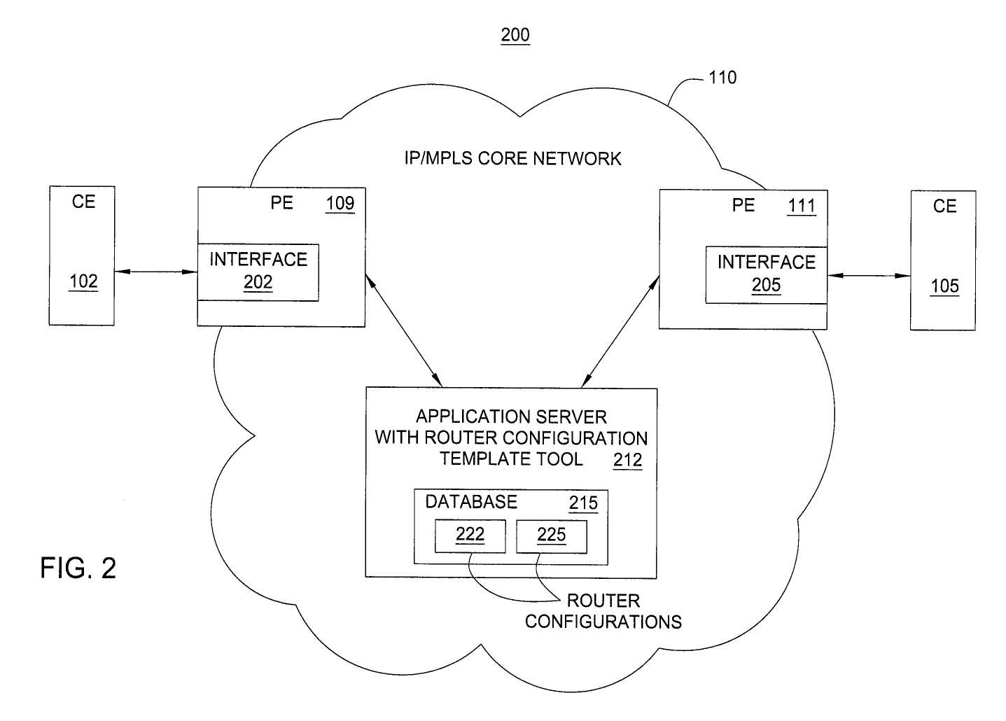

FIG. 2 illustrates an exemplary network 200 of the current invention for creating one or more router configurations and templates. For example, customer Edge (CE) router 102 is accessing services from IP/MPLS core network 110 through PE router 109. Similarly, customer edge router 105 is accessing services from IP/MPLS core network 110 through PE router 111. The IP/MPLS core network 110 also includes an application server 212. The PE router 109 interfaces with CE router 102 via interface 202. The PE router 111 interfaces with CE router 105 via interface 205.

In one embodiment, the service provider implements a router configuration template tool in application server 212. The application server 212 also contains a database 215. The application server 212 stores a set of router configurable entries (e.g. a list of managed objects), configuration options based on customer information, one or more templates with configurations for each of the router configurable entries, etc. in the database 215. It should be noted that in one embodiment, the router configuration template tool is stateless. In other words, given the diverse operational environments, the router configuration template tool will continue to interact with external databases to ensure that the most up-to-date information is used whenever a router configuration is created.

The router configuration template tool 212 instantiates a router configuration by executing one or more templates. For example, the router configuration template tool may determine the values for the configurable entries based on customer information, network information and/or the router's fixed information (e.g. a list of the router's managed objects). For example, the type of service a customer requested, available network resources, quality of resources appropriate for the requested service, etc. may be used to determine the appropriate values of a router's configurable entries.

The router configuration information may then be provided to each router in a format supported by that router. For example, different router vendors may use different formats for configuring router interfaces for affecting router configurations. The router configuration tool 212 provides each router the configuration information in a format readable by the router. For example, the PE router interfaces 202 and 205 use router configurations 222 and 225, respectively.

Table-1 provides an exemplary router configuration (or only a portion of a complete router configuration) created by executing one or more templates. The various parameters, e.g., interface number, IP address, mask number, bandwidth, traffic description, etc. may be computed and/or populated on the router.

TABLE 1
An exemplary router configuration
Router Number 123

| | |
|---|---|
| Interface | Serial 0/1/1:0.350 Point-to-point |
| Description | 1024 Kb/s enterprise Permanent Virtual |
| | Circuit (ePVC) to Call Control Agent |
| | (CCA)_01 |
| IP address | 75.72.34.10 |
| Mask | 255.255.255.252 |
| Bandwidth | 784 |
| Frame-relay interface- | 350 |
| Data-Link Connection Identifier | |
| (DLCI) | |
| No shutdown | |

In one embodiment, the instance of a router configuration may be for a router at a customer premise. For example, if the configuration is for a VPN service, the method may provide router configurations for one or more CEs, one or more PEs, etc. to enable seamless connectivity among customer endpoints in various customer locations.

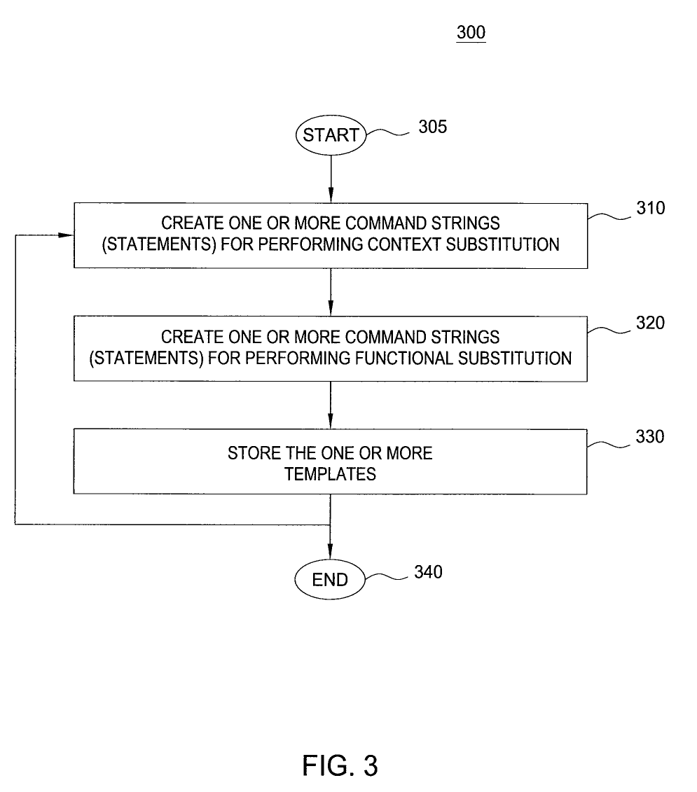

FIG. 3 illustrates a flowchart of a method 300 for creating one or more templates. Method 300 starts in step 305 and proceeds to step 310. It should be noted that the present invention presumes that one or more service and/or service features will be modeled. In other words, the model will produce one or more rules that need to be followed in order to support the service and/or service feature. In one embodiment, the rules resulting from such modeling will be implemented via one or more command lines as discussed below.

In step 310, method 300 creates one or more command strings (e.g., statements) for performing context substitution. For example, the command string may enable direct substitutions for variables in a router configuration.

In step 320, method 300 creates one or more command strings (e.g., statements) for performing functional substitution. For example, the command string may enable obtaining input from one or more databases in accordance with a conditional statement. The command string may also enable performing computations based on the obtained input to determine values for variables in a router configuration.

In step 330, method 300 stores the various command strings as one or more templates. For example, the method saves the templates, such that an application server that performs automated router configurations may use the templates. The method then ends in step 340 after creating the current template(s) or it may return to step 310 to continue creating additional templates for other services and/or routers.

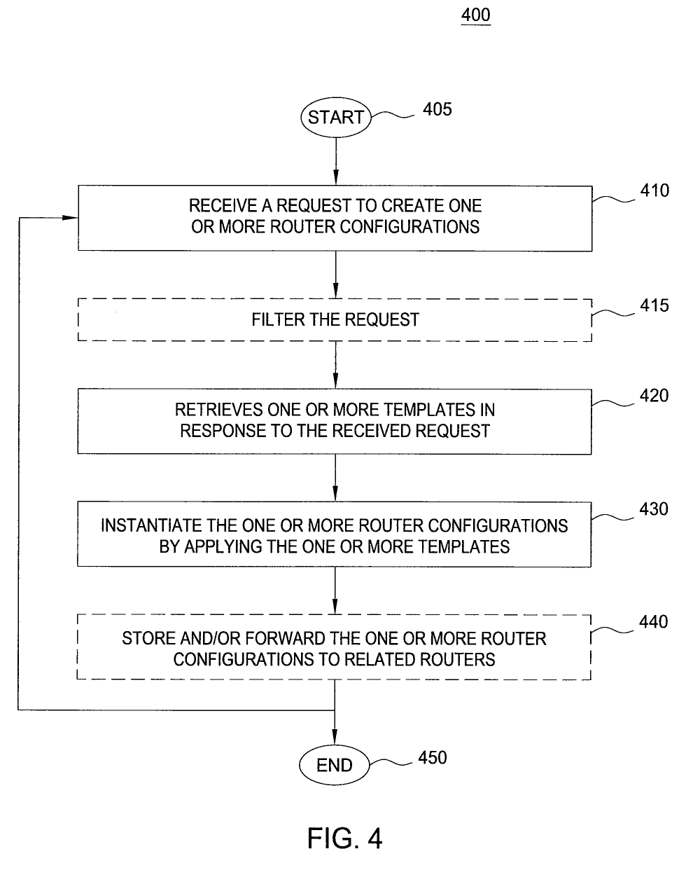

FIG. 4 illustrates a flowchart of a method 400 for creating one or more router configurations. Method 400 starts in step 405 and proceeds to step 410.

In step 410, method 400 receives a request to create one or more router configurations. For example, the service provider may receive a customer request for a service that needs a router configuration. It should be noted that in one embodiment, the request may contain various data that will be necessary to provide the proper router configurations, e.g., the specific service feature requirements that a customer is requesting and the like. If the necessary data is not provided in the request itself, then the present method may interact with the user to obtain the necessary data before the router configuration can be created in accordance with one or more templates as discussed below. On behalf of the customer, a user (e.g., a network engineer) may then send a request to an application server that executes one or more templates to create instances of router configurations. The user may provide the application server with the pertinent information, e.g., model numbers, locations, types of services, etc., for the routers to be configured.

It should be noted that various data (broadly referred to as configuration data) will be necessary to generate a proper router configuration. However, such configuration information may not be available in one central repository at the time that the configuration information is needed, but rather are distributed amongst a variety of databases. Thus, an automated system has to be cognizant of the diversity of the information source (and quality of the data). As such, a certain degree of data filtering (e.g., data cleansing or data standardization) may be required to ensure that the present method is able to interact with a diverse set of data source.

For example, in step 415, method 400 optionally applies one or more filters to the request. In other words, the request is processed to ensure that all necessary data and/or variables associated with the request have been identified and can be properly addressed in an automated fashion. However, if any necessary data and/or variables associated with the request cannot be identified or handled in an automated fashion, then the method may interact with the user (e.g., a customer) and request that the user provide the necessary data directly or have the user provide a source where such data can be obtained in an automated fashion (e.g., identifying a database having a format that can be queried by the automated method of the present invention). However, if all of the necessary data for supporting the router configurations have been previously pre-processed into a standardized form, then step 415 can be regarded as optional.

In step 420, method 400 retrieves one or more templates in response to the received request. For example, the method retrieves templates for implementing a service over a specific type of router. In other words, the method is able to parse the high level information provided in step 410 to associate one or more pertinent templates that will be needed to generate the router configuration.

In step 430, method 400 instantiates the one or more router configurations by applying the one or more templates. For example, the method creates an instance of a router configuration for each of the one or more routers in the received request, by executing the one or more templates. For example, the customer may have CE routers that are capable of interworking with the PE routers only in one specific configuration. The method then chooses the specific configuration for the CE router that enables proper operation of the CE router.

In optional step 440, method 400 stores and/or forwards the one or more router configurations to related routers. For example, the method may forward a specific configuration to each router that is to be configured in accordance with the current request. The method then ends in step 450 or returns to step 410 to continue receiving requests.

It should be noted that although not specifically specified, one or more steps of methods 300 and 400 may include a storing, displaying and/or outputting step as required for a particular application. In other words, any data, records, fields, and/or intermediate results discussed in the method 300 or method 400 can be stored, displayed and/or outputted to another device as required for a particular application. Furthermore, steps or blocks in FIG. 3 or FIG. 4 that recite a determining operation, or involve a decision, do not necessarily require that both branches of the determining operation be practiced. In other words, one of the branches of the determining operation can be deemed as an optional step.

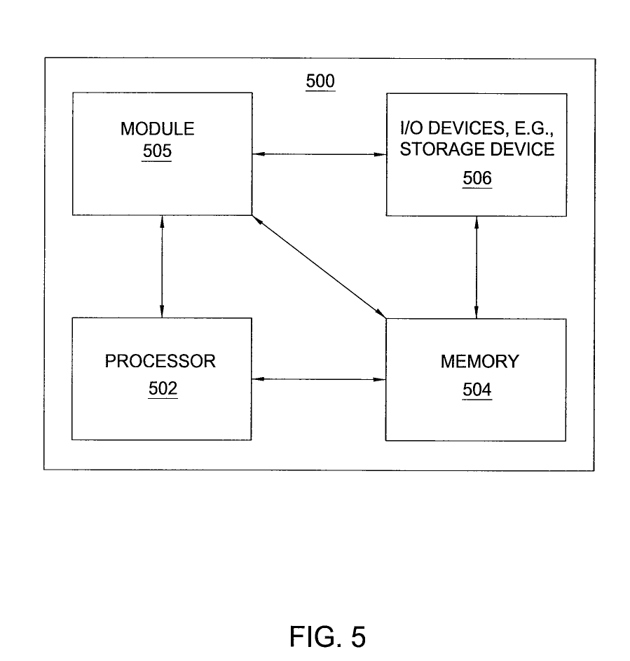

FIG. 5 depicts a high-level block diagram of a general-purpose computer suitable for use in performing the functions described herein. As depicted in FIG. 5, the system 500 comprises a processor element 502 (e.g., a CPU), a memory 504, e.g., random access memory (RAM) and/or read only memory (ROM), a module 505 for creating one or more router configurations, and various input/output devices 506 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module or process 505 for creating one or more router configurations can be loaded into memory 504 and executed by processor 502 to implement the functions as discussed above. As such, the present method 505 for creating one or more router configurations (including associated data structures) of the present invention can be stored on a computer readable medium, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for creating a router configuration, comprising:
receiving a request to create a router configuration;
retrieving automatically one or more templates in response to said request; and
instantiating said router configuration by applying said one or more templates.

2. The method of claim 1, further comprising:
forwarding said router configuration to one or more routers.

3. The method of claim 1, wherein each of said one or more templates provides a definition of a requirement for configuring a router to provide one or more services.

4. The method of claim 3, wherein said one or more services comprise at least one of: a Virtual Private Network (VPN) service, or a Voice over Internet Protocol (VOIP) service.

5. The method of claim 1, wherein each of said one or more templates comprises at least one command string that enables a context substitution or a functional substitution.

6. The method of claim 5, wherein said context substitution enables a substitution of one or more values for one or more variables in said at least one command string, wherein said one or more values are obtained from a user or a database.

7. The method of claim 5, wherein said functional substitution enables a substitution of one or more values for one or more variables in said at least one command string, by performing one or more computations on inputs obtained from a user or a database.

8. A computer-readable medium having stored thereon a plurality of instructions, the plurality of instructions including instructions which, when executed by a processor, cause the processor to perform the steps of a method for creating a router configuration, comprising:
receiving a request to create a router configuration;
retrieving automatically one or more templates in response to said request; and
instantiating said router configuration by applying said one or more templates.

9. The computer-readable medium of claim 8, further comprising:
forwarding said router configuration to one or more routers.

10. The computer-readable medium of claim 8, wherein each of said one or more templates provides a definition of a requirement for configuring a router to provide one or more services.

11. The computer-readable medium of claim 10, wherein said one or more services comprise at least one of: a Virtual Private Network (VPN) service, or a Voice over Internet Protocol (VOIP) service.

12. The computer-readable medium of claim 8, wherein each of said one or more templates comprises at least one command string that enables a context substitution or a functional substitution.

13. The computer-readable medium of claim 12, wherein said context substitution enables a substitution of one or more values for one or more variables in said at least one command string, wherein said one or more values are obtained from a user or a database.

14. The computer-readable medium of claim 12, wherein said functional substitution enables a substitution of one or more values for one or more variables in said at least one command string, by performing one or more computations on inputs obtained from a user or a database.

15. An apparatus for creating a router configuration, comprising:
means for receiving a request to create a router configuration;
means for retrieving automatically one or more templates in response to said request; and
means for instantiating said router configuration by applying said one or more templates.

16. The apparatus of claim 15, further comprising:
means for forwarding said router configuration to one or more routers.

17. The apparatus of claim 15, wherein each of said one or more templates provides a definition of a requirement for configuring a router to provide one or more services.

18. The apparatus of claim 17, wherein said one or more services comprise at least one of: a Virtual Private Network (VPN) service, or a Voice over Internet Protocol (VOIP) service.

19. The apparatus of claim 15, wherein each of said one or more templates comprises at least one command string that enables a context substitution or a functional substitution.

20. The apparatus of claim 19, wherein said context substitution enables a substitution of one or more values for one or more variables in said at least one command string, wherein said one or more values are obtained from a user or a database, and wherein said functional substitution enables a substitution of one or more values for one or more variables in said at least one command string, by performing one or more computations on inputs obtained from a user or a database.
